(19) United States
(12) Patent Application Publication
(10) Pub. No.: US 2018/0101576 A1
(43) Pub. Date: Apr. 12, 2018

(54) Content Recommendation and Display

(71) Applicant: Alibaba Group Holding Limited, Grand Cayman (KY)

(72) Inventors: Xuqian Lin, Hangzhou (CN); Xiaolin Mu, Hangzhou (CN)

(73) Assignee: Alibaba Group Holding Limited

(21) Appl. No.: 15/724,174

(22) Filed: Oct. 3, 2017

(30) Foreign Application Priority Data
Oct. 10, 2016 (CN) 201610885115.2

(51) Int. Cl. G06F 17/30; G06F 3/16; G06F 17/27; G06Q 30/00

(52) U.S. Cl. CPC G06F 17/30522; G06F 3/167; H04L 67/42; G06F 17/30867; G06Q 30/016; G06F 17/2785

(57) ABSTRACT

A system including a basic content pool; a server for content recommendation; and a client terminal. The basic content pool stores one or more contents. The client terminal monitors a user input and provides the user input to the server for content recommendation. The server for content recommendation receives the user input provided by the client terminal, creates a personal content pool for the user, searches matching contents from the basic content pool according to the user input, and inputs the matching contents into the personal content pool. The client terminal, when a preset triggering condition is satisfied, receives a content provided by the server for content recommendation from the personal content pool, and displays the content. The techniques of the present disclosure provide individualized search service, thereby improving user experiences.

### CROSS REFERENCE TO RELATED PATENT APPLICATIONS

This application claims priority to Chinese Patent Application No. 201610885115.2, filed on 10 Oct. 2016 entitled “Method, Client Terminal, Server, and System for Content Recommendation and Display,” which is hereby incorporated by reference in their entirety.

### TECHNICAL FIELD

The present disclosure relates to the field of computer network communication technology, and, more particularly, to methods, client terminals, servers, and systems for content recommendation and display.

### BACKGROUND

With the continuous development of computer network communication technology, online shopping is becoming more and more common. Especially for the younger generation, online shopping is becoming part of everyday life. Currently, users may shop for products or services online by using client terminals to visit online sale platform. The client terminal may be a particular online shopping application or a general-purpose web browser. No matter through which client terminal online shopping is conducted, the user generally can only perform general search operations such that the user inputs a phrase to conduct a search (or sets a filter condition when inputting the phrase) and the server, according to the phrase input by the user (or according to the phrase and the filter condition), matches corresponding contents from the database of the online sale platform and returns them to the user for shopping.

In the above search scenario, the server usually returns many search results and the user generally will tend to change different input phrases to obtain more accurate search results. However, with respect to a common user that is not good at selecting the combination of terms to input for a search, he/she might not obtain the more accurate search results after frequent changes of input phrases. That is, after efforts, the user might still face the problem to select proper content from a lot of search results. The server cannot further provide individualized search service to the user, thereby negatively impacting the user experience.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure.

The present disclosure provides a method comprising:

receiving a user input provided by a client terminal; searching for matching contents from a basic content pool according to the user input, the basic content pool including one or more contents;

creating a personal content pool to store contents for a user;

inputting the matching contents into the personal content pool; and

providing a content from the personal content pool to the client terminal when a preset triggering condition is satisfied, the preset triggering condition indicating attempts of the user to search for the matching contents have reached a threshold.

For example, the user input includes a natural language input at a natural language interactive interface of the client terminal.

For example, the preset triggering condition includes a quantity of contents in the personal content pool reaches a preset threshold value.

For example, the preset triggering condition includes a time period after receiving the user input reaches a preset threshold of time period.

For example, the preset triggering condition includes a quantity of times that keywords input for a same scenario has reached a threshold times.

For example, the user input includes a keyword input at a search bar of the client terminal.

For example, wherein the preset triggering condition includes a quantity of contents that has been viewed or clicked in a search result reaches a preset threshold number.

For example, the method further comprises, after providing the content from the personal content pool to the client terminal, records a recommendation.

For example, the method of claim further comprises, before providing the content in the personal content pool to the client terminal at a next time, determining whether to provide the content from the personal content pool to the client terminal according to a record; and determining not to provide the content from the personal content pool to the client terminal at the next time in respond to determining that the content is recorded.

For example, the method further comprises:

providing a prompt message to the client terminal; and

selecting multiple contents from the personal content pool to provide to the client terminal after receiving a view request provided by the client terminal.

For example, the method further comprises

receives a recommendation request from the client terminal; and

returning one or more online customer service interfaces of one or more merchants to the client terminal according to a preset reference condition.

For example, the preset reference condition includes at least one of the following:

a busy degree of an online customer service of a merchant;

a professional level of an online customer service of a merchant; and

the user input within a preset threshold of time after an initiation of the user input.

For example, the providing the content from the personal content pool to the client terminal includes:

receiving a view request from the client terminal, the view request being triggered when the operation tag displayed at the client terminal is clicked or triggered; and

after selecting multiple contents from the personal content pool, selecting a preset quantity of contents from the multiple contents to be sent to the client terminal.

For example, the method further comprises:

receiving an improved user input from the client terminal;

retrieving contents matching the improved user input from the basic content pool;

inputting the contents matching the improved use input into the personal content pool; and

providing the contents matching the improved use input to the client terminal.

For example, the personal content pool has a life cycle. The personal content pool includes contents that may be interested by the particular user.

For example, the creating the personal content pool includes creating the personal content pool when detecting a user interaction at a user interaction interface of the client terminal. For instance, such user interaction includes the user input at the user interface provided by the client terminal.

For example, the method further includes deleting the personal content pool when detecting the user interaction at the user interaction interface is completed. For instance, it may be regarded that the user has left the user interface or the user interaction at the user interaction is completed when the user interface for receiving the user input has not received new user input for more than a preset threshold of time. For instance, it may be regarded that the user has left the user interface or the user interaction at the user interaction is completed when there is a particular page used for receiving the user input and the user opens another page or closes the particular page.

For example, the method further includes deleting the personal content pool when an account of the user is deleted. For instance, the user may have an account at the server or a third-party web site at another server. The server receives a notification that the user closes the account. Then the personal content pool for the user is deleted.

The present disclosure also provides a method comprising:

receiving a user input via a user interface;

providing the user input to a server for content recommendation;

when a preset triggering condition is satisfied, receiving a content provided by the server for content recommendation from a personal content pool; and

displaying the content.

For example, the user interface is a natural language user interface.

For example, the preset triggering condition includes at least one of the following:

a quantity of contents in the personal content pool reaches a preset threshold value;

a time period after receiving the user input reaches a preset threshold of time period; and

a quantity of times that keywords input for a same scenario has reached a threshold times.

The present disclosure also provides a client terminal comprising:

one or more processors; and

one or more computer readable media storing thereon computer-readable instructions, that when executed by the one or more processors, cause the one or more processors to perform acts comprising:
receiving a user input via a user interface;
providing the user input to a server for content recommendation;
receiving a content provided by the server for content recommendation from a personal content pool when a preset triggering condition is satisfied; and
displaying the content.

For example, the user interface is a natural language user interface.

For example, the preset triggering condition indicates attempts of the user to find an accurate user input for searching have reached a threshold.

More particularly, for example, the preset triggering condition may include at least one of the following:

a quantity of contents in the personal content pool reaches a preset threshold value;

a time period after receiving the user input reaches a preset threshold of time period; and

a quantity of times that multiple user inputs intending to describe a same scenario has reached a threshold times; or

For example, the user interface is received by a receiving device of the client terminal.

For example, the content is displayed at a display device of the client terminal.

The present disclosure also provides a server comprising:

one or more processors; and

one or more computer readable media storing thereon computer-readable instructions, that when executed by the one or more processors, cause the one or more processors to perform acts comprising:
receiving a user input provided by a client terminal;
searching matching contents from a basic content pool according to the user input;
creating a personal content pool;
inputting the matching contents into a personal content pool; and
when a preset triggering condition is satisfied, providing a content from the personal content pool to the client terminal.

The present disclosure also provides a method, client terminal, server, and system for content recommendation and display, to provide an individualized search service for the user and improve user experiences.

To achieve the above purpose, the present disclosure provides a system for content recommendation, which includes a basic content pool, a server for content recommendation, and at least one client terminal.

The basic content pool stores one or more contents.

The client terminal monitors a user input and provides it to the server for content recommendation.

The server for content recommendation receives the user input provided by the client terminal, creates a personal content pool for the user, searches content matching the user input from the basic content pool according to the use input, and inputs the matched content into the personal content pool.

The client terminal, when a preset triggering condition is satisfied, receives the content provided by the server for content recommendation from the personal content pool and displays the content to the user.

In addition, the present disclosure also provides a method for content recommendation, which includes:

receiving a user input from the client terminal to create a personal content pool for the user; and

searching content matching the user input from a basic content pool according to the use input, and inputting the matched content into the personal content pool.

In addition, the present disclosure also provides a server for content recommendation, which includes:

one or more processors; and

one or more computer readable media that store therein a plurality of units and modules including an apparatus for content recommendation. When the apparatus for content recommendation is executed by the one or more processors, the following acts are performed:

receiving a user input from the client terminal to create a personal content pool for the user; and

searching content matching the user input from a basic content pool according to the use input, and inputting the matched content into the personal content pool.

In addition, the present disclosure also provides a method for content display, which includes:

monitoring the user input and providing it to the server for content recommendation,

when a preset triggering condition is satisfied, receiving the content provided by the server for content recommendation from the personal content pool and displaying the content to the user.

In addition, the present disclosure also provides a client terminal, which includes:

one or more input devices that receive the user input from the user;

one or more processors coupled with the input devices that provide the user input to the server for content recommendation, and, when a preset triggering condition is satisfied, receive the content provided by the server for content recommendation from the personal content pool; and

a display device that display the content to the user.

In the present disclosure, the basic content pool stores one or more contents. The client terminal, after monitoring the input from the user, provides the user input to the server for content recommendation. The server for content recommendation receives the user input provided by the client terminal to create the personal content pool for the user, searches content matching the user input from the basic content pool according to the use input, and inputs the matched content into the personal content pool. The client terminal, when a preset triggering condition is satisfied, receives the content provided by the server for content recommendation from the personal content pool and displays the content to the user. Thus, individualized search service is provided to the user. When the user faces search difficulty or search result selection difficulty, the present disclosure provides certain recommendation and decision-making, capabilities, thereby improving user experience.

### BRIEF DESCRIPTION OF THE DRAWINGS

In order to more clearly illustrate the technical solutions in the embodiments or the conventional techniques of the present disclosure, the drawings for illustrating the embodiments are briefly introduced as follows. It is apparent that the FIGs only describe some of the embodiments of the present disclosure. One of ordinary skill in the art may obtain other figures according to the EEGs without using creative efforts.

FIG. 1 is a schematic diagram of an example system for content recommendation according to an example embodiment of the present disclosure;

FIG. 2 is an interactive display interface between the client terminal and the user according to an example embodiment of the present disclosure,

FIG. 3 is another interactive display interface between the client terminal and the user according to an example embodiment of the present disclosure;

FIG. 4 is a display interface that shows prompt message according to an example embodiment of the present disclosure;

FIG. 5 is a display interface that displays more contents at a client terminal according to an example embodiment of the present disclosure;

FIG. 6 is another display interface that displays more contents at a client terminal according to an example embodiment of the present disclosure;

FIG. 7 is a flowchart of an example method for content recommendation according to an embodiment of the present disclosure;

FIG. 8 is a flowchart of another example method for content recommendation according to an embodiment of the present disclosure;

FIG. 9 is a flowchart of another example method for content display according to an embodiment of the present disclosure;

FIG. 10 is a schematic diagram of an example server for content recommendation according to an example embodiment of the present disclosure;

FIG. 11 is a schematic diagram of an example client terminal according to an example embodiment of the present disclosure;

FIGS. 12a-12c are interactions at an example client terminal under specific application scenarios according to an embodiment of the present disclosure.

### DETAILED DESCRIPTION

In conjunction with the following FIGs of the present disclosure, the technical solutions in the embodiments of the present disclosure will be described. Apparently, the described embodiments merely represent some of the embodiments of the present disclosure and are note to be construed as limiting the present disclosure. All other embodiments obtained by those of ordinary skill in the art based on the embodiments of the present disclosure fall within the scope of protection of the present disclosure.

The present disclosure provides a system comprising:

a basic content pool;

a server for content recommendation; and

a client terminal,

wherein:

the basic content pool stores one or more contents;

the client terminal monitors a user input and provides the user input to the server for content recommendation;

the server for content recommendation receives the user input provided by the client terminal, creates a personal content pool for the user, searches matching contents from the basic content pool according to the user input, and inputs the matching contents into the personal content pool; and

the client terminal, when a preset triggering condition is satisfied, receives a content provided by the server for content recommendation from the personal content pool, and displays the content.

For example, the user input includes a natural language input by a user at a natural language interactive interface of the client terminal.

For example, the preset triggering condition includes at least one of the following:

a quantity of contents in the personal content pool reaches a preset threshold value;

a time period after the user starts to input the natural language reaches a preset threshold of time period; and

a quantity of times that the user changes keywords for a same scenario has reached a threshold times.

For example, wherein the user input includes a keyword input by a user at a search bar of the client terminal.

For example, the preset triggering condition includes at least one of the following:

a quantity of contents in the personal content pool reaches a preset threshold value;

a quantity of times that, the user changes keywords for a same scenario has reached a threshold times; and

a quantity of contents that the user has viewed in a search result reaches a preset threshold number.

For example, the server for content recommendation, after providing the content in the personal content pool to the client terminal, records a recommendation; and the server for content recommendation, before providing the content in the personal content pool to the client terminal at a next time, determining whether to provide the content in the personal content pool to the client terminal according to the record.

For example, the server for content recommendation provides a prompt message to the client terminal, and selects multiple contents from the personal content pool to provide to the user after receiving a view request provided by the client terminal.

For example, the client terminal receives a recommendation request from a user; and the server for content recommendation, corresponding to the recommendation request, returns one or more recommendation interfaces to the client terminal according to a preset reference condition.

For example, the preset reference condition includes at least one of the following:

a busy degree of an online customer service of a merchant;

a professional level of the online customer service of the merchant; and the user input within a preset threshold of time after an initiation of the user input.

For example, the client terminal provides an operation tag; and the server for content recommendation, after selecting the multiple contents from the personal content pool, when receiving the view request from the client terminal, selects a preset quantity of contents from the personal content pool to the user, the view request being triggered when the user operates on the operation tag.

For example, the client terminal receives an improved user input from the user; and the server for content recommendation further retrieves contents matching improved keyword from the basic content pool, and provides them to the client terminal,

The present disclosure also provides a method for content recommendation comprising:

receiving a user input of a user provided by a client terminal;

creating a personal content pool for the user;

searching matching contents from a basic content pool according to the user input;

inputting the matching contents into a personal content pool; and

when a preset triggering condition is satisfied, providing a content from the personal content pool to the client terminal.

For example, the user input includes a natural language input by a user at a natural language interactive interface of the client terminal.

For example, the preset triggering condition includes at least one of the following:

a quantity of contents in the personal content pool reaches a preset threshold value;

a time period after the user starts to input the natural language reaches a preset threshold of time period; and

a quantity of times that the user changes keywords for a same scenario has reached a threshold times.

For example, the user input includes a keyword input by a user at a search bar of the client terminal.

For example, the preset triggering condition includes at least one of the following:

a quantity of contents in the personal content pool reaches a preset threshold value;

a quantity of times that the user changes keywords for a same scenario has reached a threshold times; and

a quantity of contents that the user has viewed in a search result reaches a preset threshold number.

For example, the server for content recommendation, after providing the content in the personal content pool to the client terminal, records a recommendation; and the server for content recommendation, before providing the content in the personal content pool to the client terminal at a next time, determining whether to provide the content in the personal content pool to the client terminal according to the record.

For example, the server for content recommendation provides a prompt message to the client terminal, and selects multiple contents from the personal content pool to provide to the user after receiving a view request provided by the client terminal.

For example, the client terminal receives a recommendation request from a user; and the server for content recommendation, corresponding to the recommendation request, returns one or more recommendation interfaces to the client terminal according to a preset reference condition.

For example, the preset reference condition includes at least one of the following:

a busy degree of an online customer service of a merchant;

a professional level of the online customer service of the merchant; and.

the user input within a preset threshold of time after an initiation of the user input.

For example, the client terminal provides an operation tag; and the server for content recommendation, after selecting the multiple contents from the personal content pool, when receiving the view request from the client terminal, selects a preset quantity of contents from the personal content pool to the user, the view request being triggered when the user operates on the operation tag.

For example, the client terminal receives an improved user input from the user; and the server for content recommendation further retrieves contents matching improved keyword from the basic content pool, and provides them to the client terminal.

The present disclosure also provides a server for content recommendation comprising:

one or more processors; and

one or more computer readable media storing thereon computer-readable instructions, that when executed by the one or more processors, cause the one or more processors to perform acts comprising:
receiving a user input of a user provided by a client terminal;
creating a personal content pool for the user;
searching matching contents from a basic content pool according to the user input;
inputting the matching contents into a personal content pool; and
when a preset triggering condition is satisfied, providing a content from the personal content pool to the client terminal.

The present disclosure also provides a method for content display comprising:

monitoring a user input of a user;

providing the user input to a server for content recommendation; and

when a preset triggering condition is satisfied, receiving a content provided by the server for content recommendation from a personal content pool and displaying the content.

The present disclosure also provides a client terminal comprising:

an input device that receives a user input of a user;

a processor that provides the user input to a server for content recommendation; and, when a preset triggering condition is satisfied, receives a content provided by the server for content recommendation from a personal content pool and displaying the content; and

a display device that displays the content to the user.

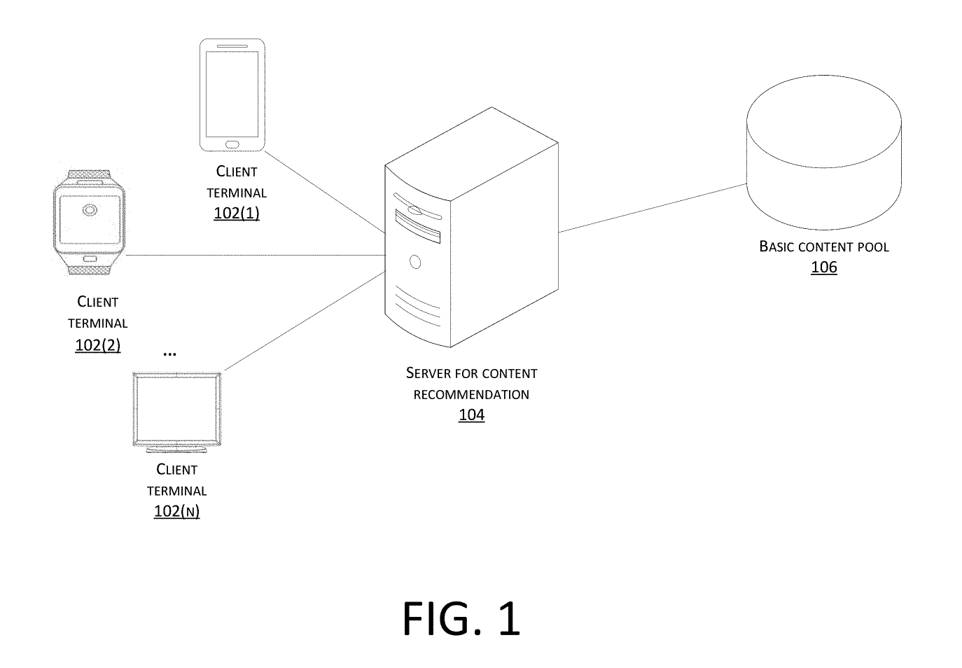

Referring to FIG. 1, the present disclosure provides a system for content recommendation that includes one or more client terminals 102 (1), 102(2), . . . , 102(n) and a server for content recommendation 104. n may be any integer. The client terminal 102 is coupled with the server for content recommendation 104. The system for content recommendation 104 may include one or more client terminals 102.

As shown in FIG. 1, in one example embodiment, the system for content recommendation 100 also includes a basic content pool 106. The basic content pool 106 is coupled with the server for content recommendation 104. The basic content pool 106 includes one or more contents as a data source for data mining. The one or more contents are a set of content information. The content information includes introduction or recommendation information of a product and/or service. For example, the content information may include an advertisement content, a usage information content, a comment information content, a product explanation content, a product ranking, detailed product information product purchase information (such as a purchase link). The content information may be in the form of text, image, video, or audio. The server for content recommendation 104, according to the search intention of the user, searches matched contents from the basic content pool 106 and recommends them to the user. The basic content pool 106 may be implemented as a database, a data warehouse, a data set etc., which is limited by the present disclosure.

The server for content recommendation 104 may be one server, or a cluster of servers including multiple servers.

In one example embodiment, when a particular user is detected to input natural language in a natural language interactive interface of the client terminal 102, the server for content recommendation 104 creates a personal content pool for the particular user, continuously conducts data mining of the matched content from the basic content pool 106 according to the natural language input by the user, and inputs the matched contents into the personal content pool of the user. When a preset first triggering condition is satisfied, the server for content recommendation 104 recommends the content in the personal content pool to the particular user. The personal content pool may be implemented as a database, a data warehouse, a data set etc., which is limited by the present disclosure.

The acts that the server for content recommendation 104 conducts data mining of the matched content from the basic content pool 106 according to the natural language input by the user may include: conducting semantic analysis of the natural language input by the user, extracting the keyword therefrom, and searching contents that match the keyword from the basic content pool 106 according to the extracted keyword. For example, when the keywords input by the user include “outdoor” and “running shoes,” the server for content recommendation 104 conducts data mining from the basic content pool 106 to find shoe advertisement content, shoe tryout report, user purchase comment, running shoe manufacturer information, world top 10 running shoes, hot sale running shoes, and product links that are associated with “outdoor running shoes,” “running shoes,” and “outdoor activities.”

The personal content pool creates for the user is temporary and has a life circle. Once its life circle ends, the server for content recommendation 104 may delete the personal content pool once its life circle ends. In one example embodiment, when the user starts to have interactive action with the natural language interactive interface of the client terminal, the personal content pool is created. After the user stops the interaction, such that the natural language interactive interface is closed or the natural language interactive interface has not received input from the user for more than a preset threshold of time, the personal content pool is deleted. In another example embodiment, when the user starts to have interactive action with the natural language interactive interface of the client terminal, the personal content pool is created. The personal content pool will be maintained until the user data (such as account) is deleted.

In the present disclosure, as the server for content recommendation 104 is capable to identify the natural language input the user, searches matched contents from the basic content pool 106 according to the natural language input the user, and recommends the matched contents to the user. Thus, it is convenient for the user to input natural language to express search intention. There is no need to change the keywords multiple times or try complex logical combination of keywords at the search tool to express the search intention under the conventional techniques. Meanwhile, the search interaction based on the natural language makes the server for content recommendation 104 finds the search intention of the user more accurately, thereby recommending more accurate and proper contents to the user.

In an example embodiment, the first triggering condition is that the number of the contents input into the personal content pool reaches a threshold value. In another example embodiment, the first triggering condition is that a time period after receiving the user input of natural language reaches a preset period of time. In another example embodiment, the first triggering condition is that, after receiving the user input of natural language, the number of times that the user changes the keywords under the same scenario has reached a threshold value. The keywords under the same scenario refer to that the keywords belong to the same or substantially same concepts. For example, if the user intends to buy a pair of sport shoes, the user searches three keywords “running shoes,” “outdoor running shoes,” and “track shoes” in a short period of time. As all these shoes are suitable for wear when running, they are regarded as the keywords under the same scenario.

In an example embodiment, when the preset first triggering condition is satisfied, the server for content recommendation 104 searches multiple contents to the user from the personal content pool of the user. When the server for content recommendation 104 finds that the user needs more recommendations, the server for content recommendation 104 will select more contents from the personal content pool of the user and recommend them to the user. The selected contents may be random or preferred choice based on parameter dimensions such as a relevancy degree.

In an example embodiment, the server for content recommendation 104 also provides an interface for shopping guide to the client terminal 102. When the interface receives a request for shopping guide from the user via the client terminal 102, the server for content recommendation 104 recommends online customer service of one or more merchants to the user according to one or more preset reference conditions. The user may select from the one or more merchants. The reference conditions may include a busy degree of the online customer service of a merchant, a professional level of the online customer service of the merchant, and/or the natural language input the user within a preset threshold of time after the user initiates the inputting of the natural language.

Due to the limitation of the current technology, it is apparent that a communication between human and machine is less convenient than that between humans. Thus, by the assistance of the shopping guide, the user is more convenient to express his/her search intentions. After understanding the search intention of the user, the online customer service of the merchant may also provide more accurate search contents to the user than the machine search. Meanwhile, as the online customer service of the merchant provided to the user is selected after considering factors such as the business degree and professional level of the online customer service of the merchant, the user may quickly and conveniently obtain professional and accurate recommendation contents through this type of shopping guide, thereby improving user experience.

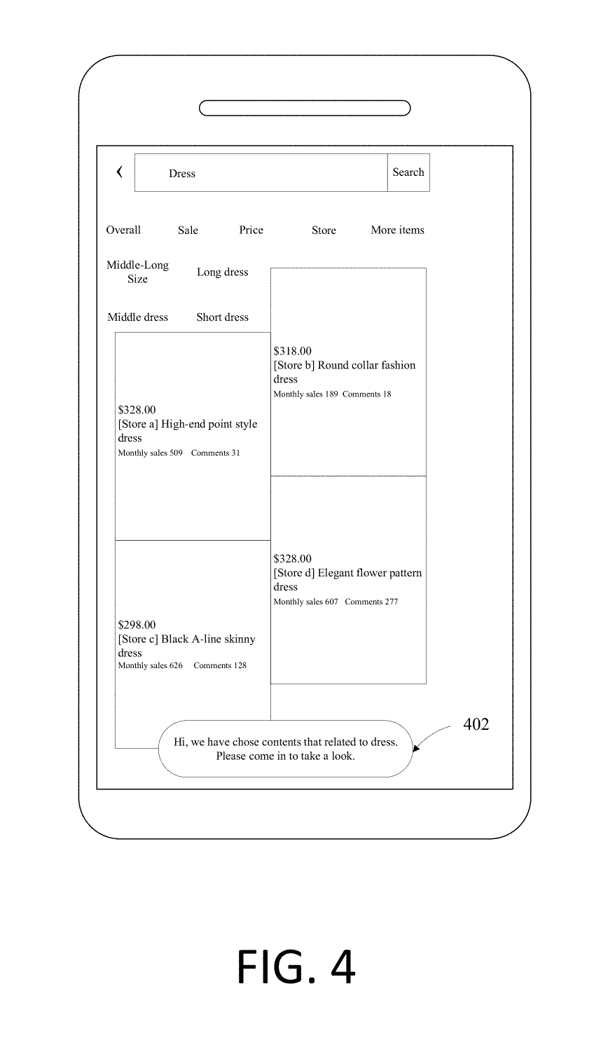

In an example embodiment, the client terminal 102 provides a search bar that provides similar search functions of general purpose online shopping website (such as the client terminal of JD.com or the client terminal of Amazon.com). When the keyword (such as “dress” as shown in FIG. 4) is detected to input into the search bar of the client terminal 102 by the user, the server for content recommendation 104 creates a personal content pool of the particular user, searches matched contents from the basic content pool 106 according to the keyword input by the user, and inputs the matched contents into the personal content pool of the particular user. When a preset second triggering condition is satisfied, the server for content recommendation 104 recommends the contents in the personal content pool to the user.

In an example embodiment, when the user starts to input the keyword into the search bar, the server for content recommendation 104 creates the personal content pool. When the user closes the application software or the website, the personal content pool is deleted. In another example embodiment, when the user starts to input the keyword into the search bar, the server for content recommendation 104 creates the personal content pool. The server for content recommendation 104 maintains the personal content pool until the user deletes the user data on the application software or website (such as user account).

In an example embodiment, the preset second triggering condition is that: after the user inputs the keyword, the number of times that the keywords for the same scenario are changed has reached a threshold value. Generally, if the user finds the proper content by one search, the user will not input new keywords to waste time. Correspondingly, if the user frequently changes the keywords for the same scenario in a preset short period of time, it may indicate that the user is difficult to find the properly content and thus it is assumed that the user is in a search difficulty.

In an example embodiment, the preset second triggering condition is that the number of contents in the search results that the user views or clicks reaches a preset threshold value. The search results are the search results of the keywords for the same scenario. Generally, the returned search results include many contents. If the number of contents that the user views or clicks reaches the preset threshold value, it indicates that the user has a difficulty in selecting contents and thus it is assumed that the user is in a selection difficulty.

In an example embodiment, the preset second triggering condition is that the number of contents input into the personal content pool reaches a threshold value,

In the above example embodiments, the purpose that the server for content recommendation 104 determines whether the preset second triggering condition is satisfied is to determine whether the user has search difficulty or selection difficulty. When the user is determined to have search difficulty or selection difficulty, the server for content recommendation 104 recommends the contents in the personal content pool to the user, thereby providing certain recommendation and decision capability to the user to help the user finish searching and selecting contents.

In an example embodiment, when the preset second triggering condition is satisfied, the server for content recommendation 104 selects multiple contents from the personal content pool of the user and recommends them to the user. When determining that the user needs more recommendation, the server for content recommendation 104 selects more contents from the personal content pool of the user and recommends them to the user.

In an example embodiment, prior to pushing the contents to the user, the server for content recommendation 104 sends a prompting message to the user (such as the floating layer 402 as shown in FIG. 4) to remind the user that the recommendation contents are ready. When the user operates on the prompting message, the server for content recommendation 104 pushes multiple contents to the user. Within a preset period of time after the prompting message is sent to the user, if the user does not operate on the prompting message, it indicates that the user is not willing to accept recommendations. The serer for content recommendation 104 closes the prompting message to not to disturb the user. In addition, to reminder the user, the prompting message may be highlighted, such as high-brightness display, high-contrast display.

In an example embodiment, prior to pushing the contents of the personal content pool to the corresponding client terminal 102, the server for content recommendation 104 determines whether the content of same scenario has recommended to the user. If the content has not been recommended to the user, the server for content recommendation 104 pushes the content to the user. Otherwise, the server for content recommendation 104 gives up the pushing to avoid repeatedly pushing the same content to impact user experiences. Certainly, to determine whether the content of the same scenario has been recommended to the user, the server for content recommendation 104 records recommended user and the recommendation content for each recommendation,

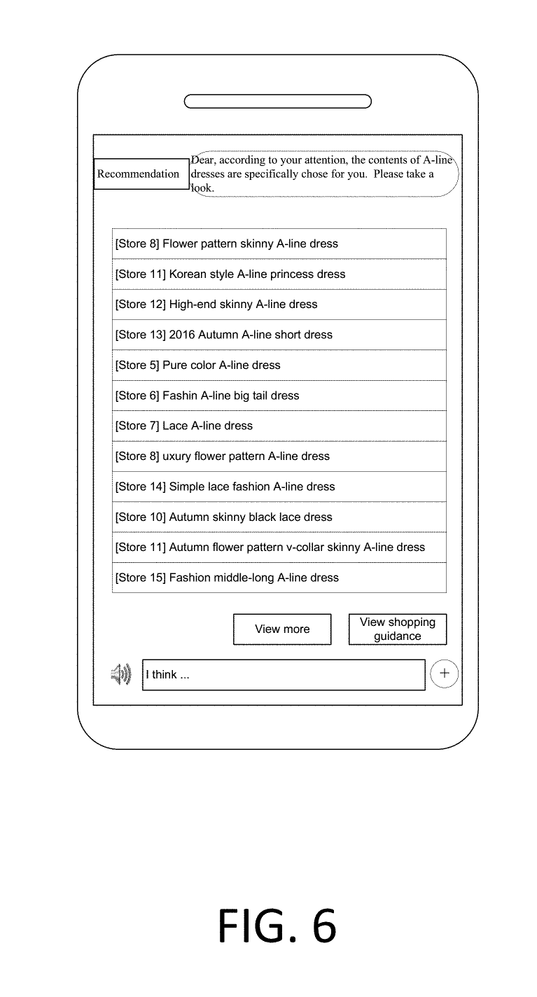

In an example embodiment, after the client terminal 102. displays the content to the user, the client terminal 102, the sever for content recommendation 104, or both monitor the operation of the user on content. When the user requests to view more contents, the server for content recommendation 104 adjusts the contents recommended to the user according to the user's operation on the user. The monitoring may include monitor a stay time of the user on the viewed content (the longer the user stays at a particular content, the higher the user's attention degree is). The monitoring may also include monitor a click behavior of the user to determine an attention point of the user based on the user's click behavior. For example, the user only clicks the “long A-line spring and autumn knit dress” or the “short sleeve A-line white dress,” as they all belong to A-line dress, the user is determined to have more attention to the A-line dress. When the user requests to view more dresses, the contents of A-line dresses in the personal content pool of the user are recommended to the user, as shown in FIG. 6,

In an example embodiment, the server for content recommendation 104 generally receives massive data from multiple client terminals 102 every day. The massive data includes keywords input by the user in the search bar of the client terminal 102 and/or natural language input by the user in the natural language interactive interface of the corresponding client terminal 102. This will consume a lot of resources of the server for content recommendation 104. To ensure collecting data in real-time, the server for content recommendation 104 may process the uploaded data by using multiple-thread asynchronous queue, distributive processing, etc.

In an example embodiment, the basic content pool 106 may be a database.

In an example embodiment, the basic content pool 106 clusters introductory information or recommendation information of product and/or service, such as news, comments, activities, knowledge. For example, top 10 information of cream published by a. cosmetic brand, fashion cloth information published by a third party media website, new brief case publishing information published by a luxury band, clothing information of certain star published by the third party media website, wine shopping knowledge published by the third party media website, summer clothing match skill published by the third party media website, a review report of a top-sell smartphone published by the third party media website.

In an example embodiment, the contents stored in the basic content pool 106 have life cycles. With the introduction of new contents and deletion of old contents, the basic content pool 106 is updated continuously to meet the user requirements.

In an example embodiment, the client terminal 102 may be a mobile device, such as a smart portable terminal, a tablet device, a vehicle-mounted device, a smart wearable device. The client terminal 102 may also be a desktop device, such as a desktop personal computer (PC), an all-in-one computer, a smart self-help terminal.

The user may use different client terminals 102 to communicate with the server for content recommendation 104 to complete one or more operations of the embodiments of the present disclosure.

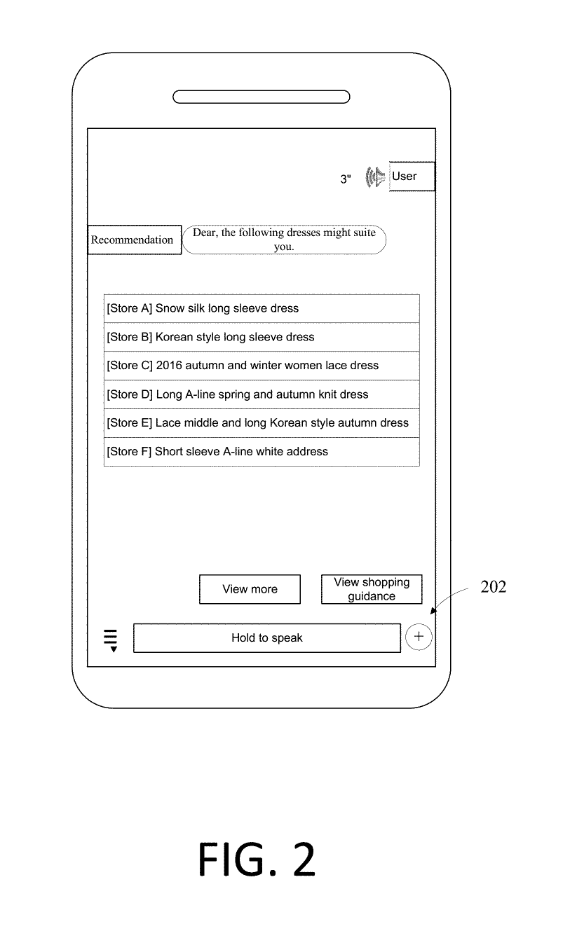

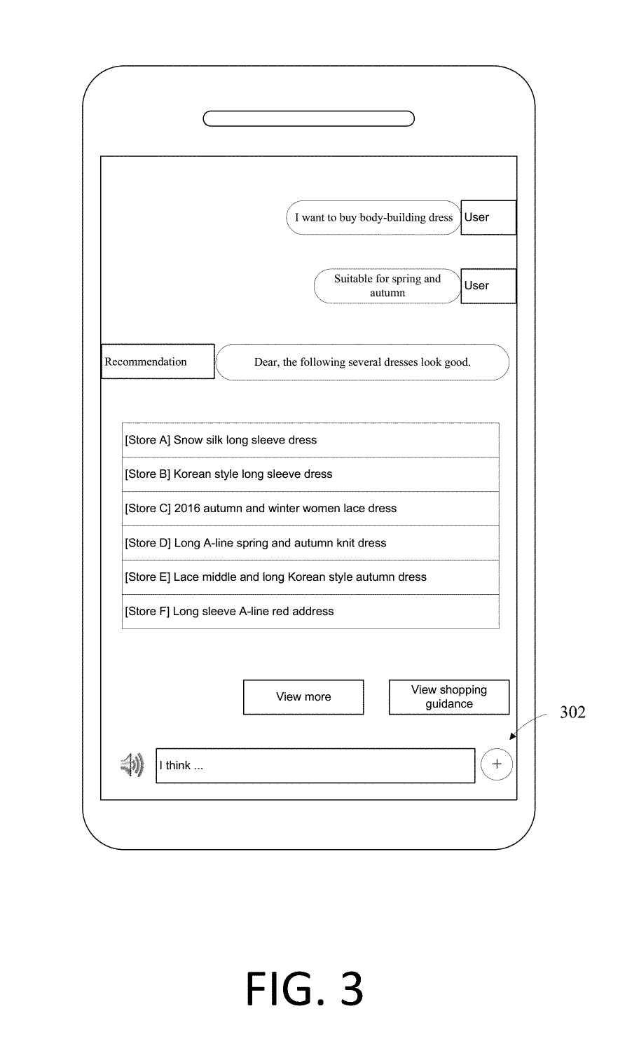

In an example embodiment, the client terminal 102 provides a natural language interactive interface (as label 202 in FIG. 2 or label 302 in FIG.). The user conducts natural language interaction for the purpose of searching through the natural language interactive interface of the client terminal 102 with the server for content recommendation 104. Referring to FIG. 2, in an example embodiment, the natural language interaction is a natural language interaction in a mix form of text and audio. As compared to the natural language in the form of text, it may be more convenient for the user to input the natural language in the form of audio. The natural language in the form of text returned by the server for content recommendation 104 is also convenient for the user to view. Referring to FIG. 3, in another example embodiment, the natural language interaction may be in the form of the text. In another example embodiment, the natural language interaction may be in the form of the audio. If the natural language input by the user is in the form of audio, before semantic analysis, the server for content recommendation 104 also converts the natural language from audio to text.

In an example embodiment, when the server for content recommendation 104 receives the content recommended to the user, the client terminal 102 displays the content to the user to view and select. In an example embodiment, by default, the client terminal 102 receives multiple contents recommended to the user by the server for content recommendation 104 to facilitate the user to view and select, as shown in FIGS. 2 and 3.

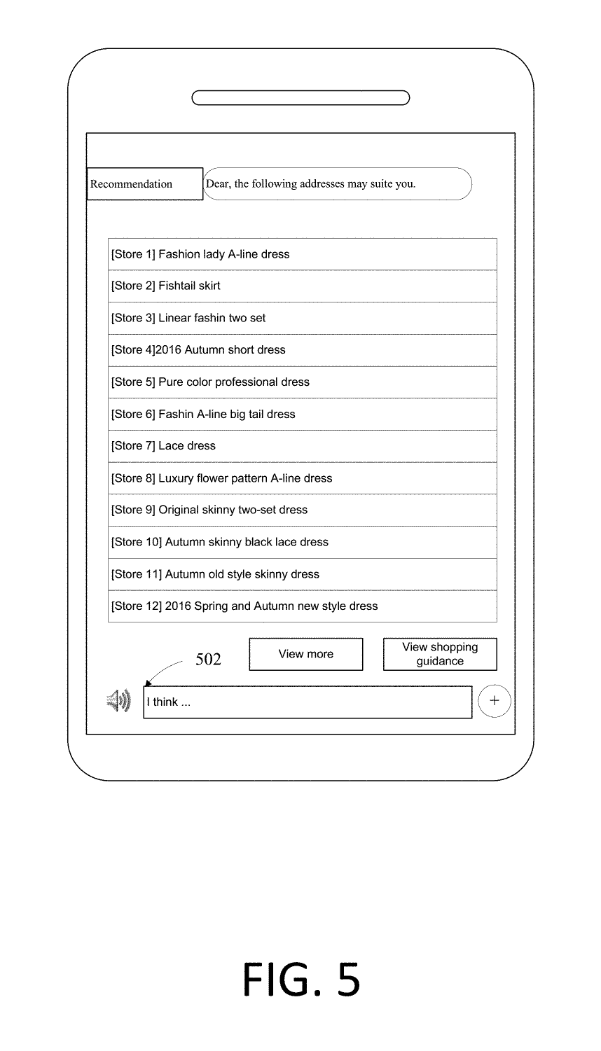

In an example embodiment, the client terminal 102 sets more operation tags such as “view more.” After the user clicks the “view more” operation tag, the client terminal 102 requests more contents from the server for content recommendation 104 and displays the contents to the user after receiving the contents returned by the server for content recommendation, as shown in FIG. 5.

In an example embodiment, the client terminal 102 also sets an operation tag “view shopping guidance.” When the user clicks the operation tag “view shopping guidance,” the client terminal 102 sends the request for manual shopping guidance to the server for content recommendation 104. After receiving one or more online customer service interfaces of merchants returned by the server for content recommendation 104, the client terminal 102 displays the online customer service interfaces to the user for selection.

In an example embodiment, after the user views the contents returned by the client terminal 102, other natural language or keyword may be input through the client terminal 102 (such as via the “I think . . . ” input box 502 as shown in FIG. 5). According to the user's further input, the server for content recommendation 104 may search one or more contents that match the user's further input and push them to the client terminal 102 to display to the user. Based on such further interaction, more matching contents are provided to the user.

In an example embodiment, to implement real-time recommendation, the client terminal 102 may collect the user input in real time, and upload them to the server for content recommendation 104. To reduce network resources, the client terminal 102 may collect data only when the user conducts input operation.

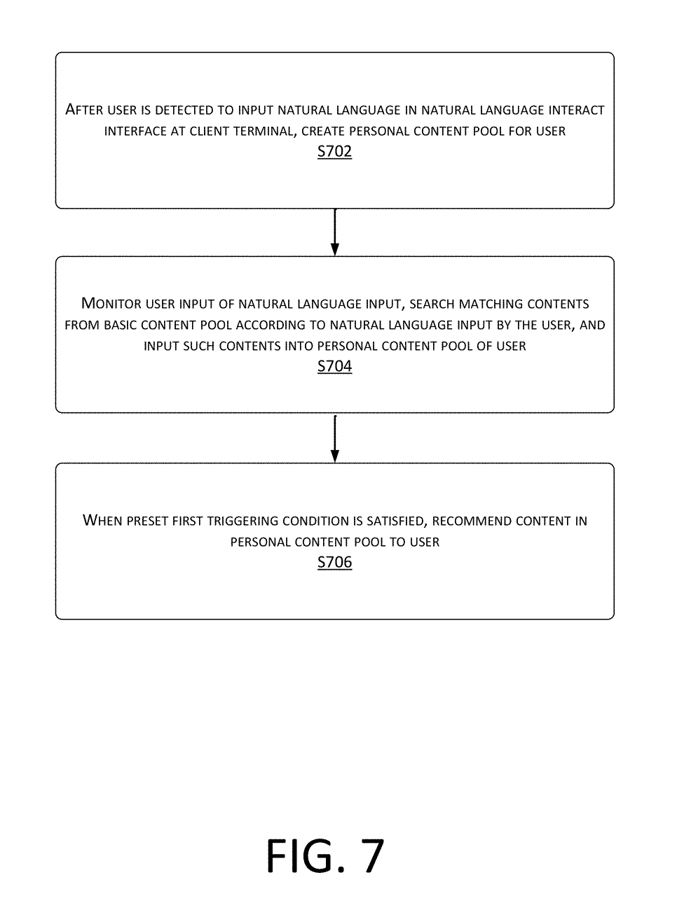

Referring to FIG. 7, in an example embodiment, the method for content recommendation may include the following operations:

S702, after the user is detected to input natural language in a natural language interact interface at the client terminal, the personal content pool is created for the user.

The performing entity of this example embodiment may be the client terminal and the server for content recommendation.

In an example embodiment, when the user intends to search content, the natural language is input into the natural language interactive interface of the client terminal (as label 202 as shown in FIG. 2 or label 302 as shown in FIG. 3). After the natural language interactive interface of the client terminal receives the natural language input by the user such natural language is uploaded to the server for content recommendation 104.

S704: the server for content recommendation monitors the user input of the natural language input, searches matching contents from the basic content pool according to the natural language input by the user, and inputs such contents into the personal content pool of the user.

In an example embodiment, it is a continuous process for the server for content recommendation to input into a personal content pool. During the process, when the user inputs the natural language, the server for content recommendation 104 searches matching contents from the basic content pool 106 according to the natural language input by the user from the starting point that the user starts to input the natural language to the ending point that the user finishes inputting the natural language.

Referring to FIG. 2, from the time that the user starts to input the natural language to the current time, the user inputs the natural language in audio form in one sentence (whose text is “I want to buy body-building dress,” the server for content recommendation conducts semantic analysis to the sentence “I want to buy body-building dress,”, extracts keywords “body-building” and “dress” from the sentence, and searches matching contents from the basic content pool according to the keywords. Referring to FIG. 3, from the time that the user starts to input the natural language to the current time, the user inputs natural language that is more one sentence such as “I want to buyer body-building dress” and “suitable for Spring and Autumn.” The server for content recommendation conducts semantic analysis to the sentences “I want to buyer body-building dress” and “suitable for Spring and Autumn” to extract the keywords “body-building,” “dress,” “Spring,” and “Autumn,” and then searches matching contents from the basic content pool according to “body-building,” “dress,” and “Spring,” and “body-building,” “dress,” and “Autumn.” Generally from the time that the user starts to input the natural language to the current time, the more natural language the user inputs, the more accurate is the content searched by the server for content recommendation from the basic content pool.

S706, when the preset first triggering condition is satisfied, the content in the personal content pool is recommended to the user.

The preset first triggering condition and the method for recommending the content in the personal content pool to the user may be refer to the corresponding portions in the above example system embodiment, and are not detailed herein for brevity. It should be noted that the undetailed portions in the example method embodiments may also refer to the above example system embodiments.

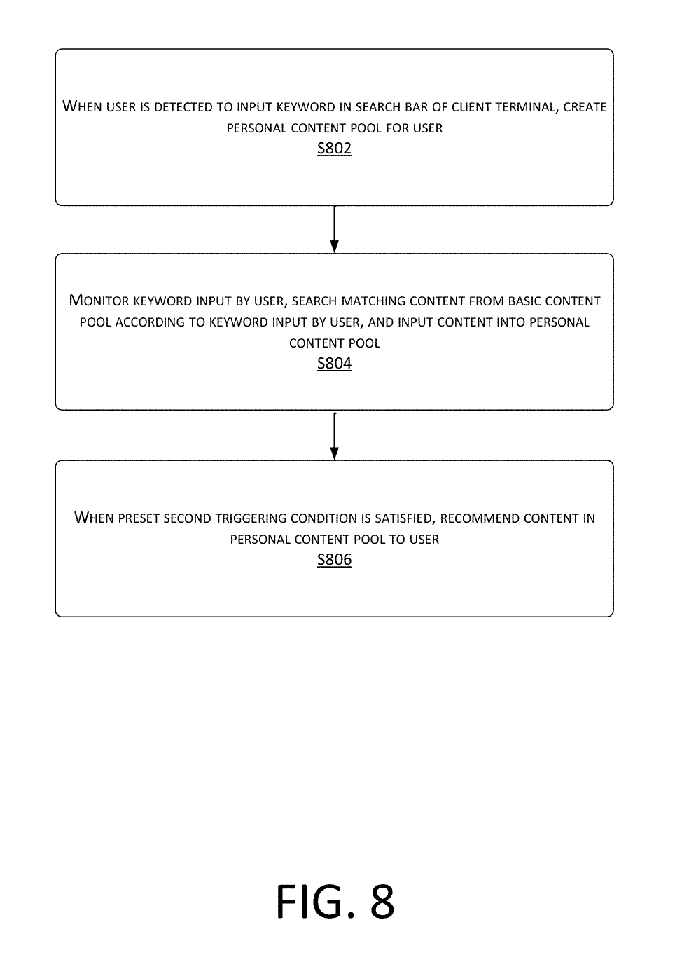

Referring to FIG. 8, in an example embodiment, the method for content recommendation may include the following operations.

S802, when the user is detected to input the keyword in the search bar of the client terminal, the personal content pool is created for the user.

The performing entities of the example embodiment may be the client terminal and the server for content recommendation.

In an example embodiment, when the user intends to search content, the keyword (such as the “dress” as shown in FIG. 4) is input into the search bar of the client terminal. After the search bar of the client terminal receives the keyword input by the user, the keyword is uploaded to the server for content recommendation.

S804, the server for content recommendation monitors the keyword input by the user, searches matching content from the basic content pool according to the keyword input by the user, and inputs the content into the personal content pool.

In an example embodiment, the input by the server for content recommendation to the personal content pool is continuous process. During the process, when the user inputs the keyword, the server for content recommendation, according to the natural language input by the user from the time that the user starts to input keyword to the current time, searches matching content from the basic content pool. The detailed process of data mining may refer to the above example method embodiment as shown in FIG. 7, which is not detailed herein for purpose of brevity.

S806, when the preset second triggering condition is satisfied, the content in the personal content pool is recommended to the user.

The preset second triggering condition and the method for recommending the content in the personal content pool to the user may be refer to the corresponding portions in the above example system embodiment, and are not detailed herein for brevity. It should be noted that the undetailed portions in the example method embodiments may also refer to the above example system embodiments.

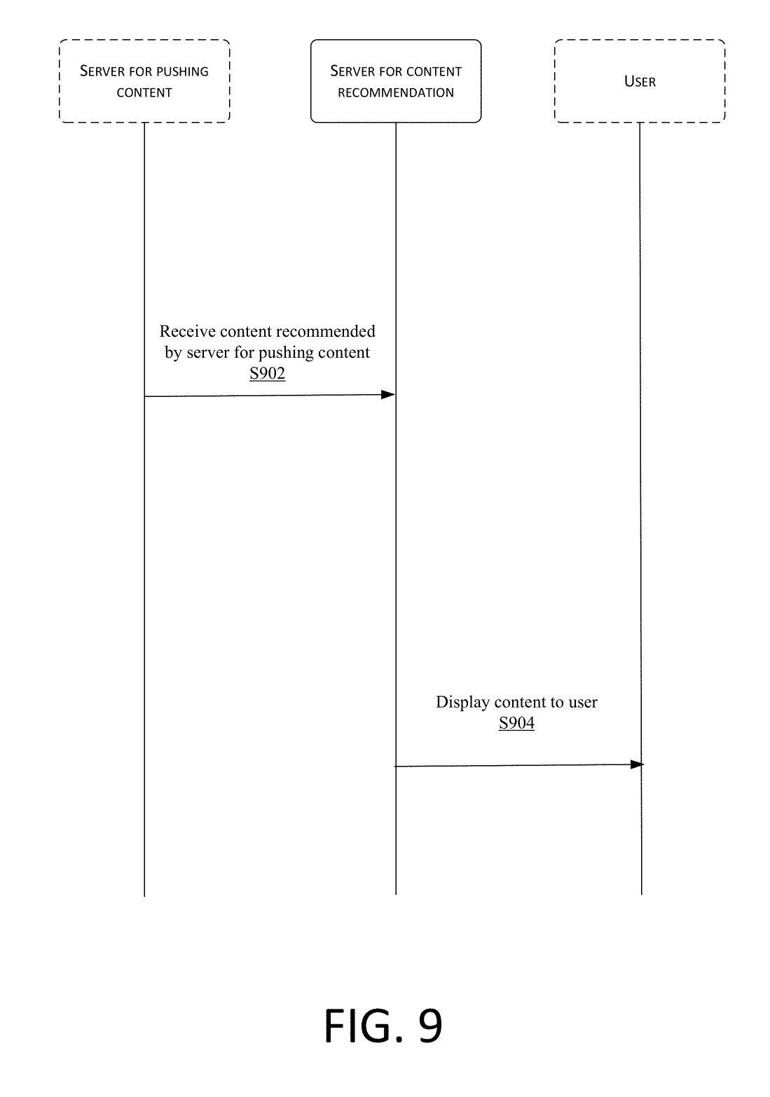

Referring to FIG. 9, in an example embodiment, the method for content display may include the following operations.

S902, the content recommended by the server for pushing content is received.

The performing entity in the example embodiment may be the client terminal. The content may be the content searched from the basic content pool by the server for pushing content.

In the example embodiment, the content received by the client may be obtained as follows.

When the user intends to search content, the keyword (such as the “dress” as shown in FIG. 4) is input into the search bar of the client terminal, or the language natural language input is input in the natural language interactive interface of the client terminal (as shown in FIG. 2 or 3). Correspondingly, after the search bar or the natural language interactive interface of the client terminal receives the input by the user, the user input is uploaded to the server for content recommendation. Meanwhile, the server for pushing content detects the user input, and creates the personal content pool for the user. Then the server for pushing content, according to the user input, searches the matching content from the basic content pool, and inputs the content into the personal content pool of the user. After a preset condition is satisfied, the server for pushing content pushes the content in the personal content pool to the client to recommend to the user.

S904, the content is displayed to the user.

In the example method embodiment, the process that the client terminal displays the content and the undetailed portion in the example method embodiment may be refer to the corresponding portions in the above example system embodiment, which are not detailed herein,

Although the above described process includes a series of operations in a specific sequence, it should be noted that the process may include more or less operations, and the operations may be performed concurrently or sequentially (such as using parallel processors or multi-thread environment). The operations may be also done in a sequence other than those described herein.

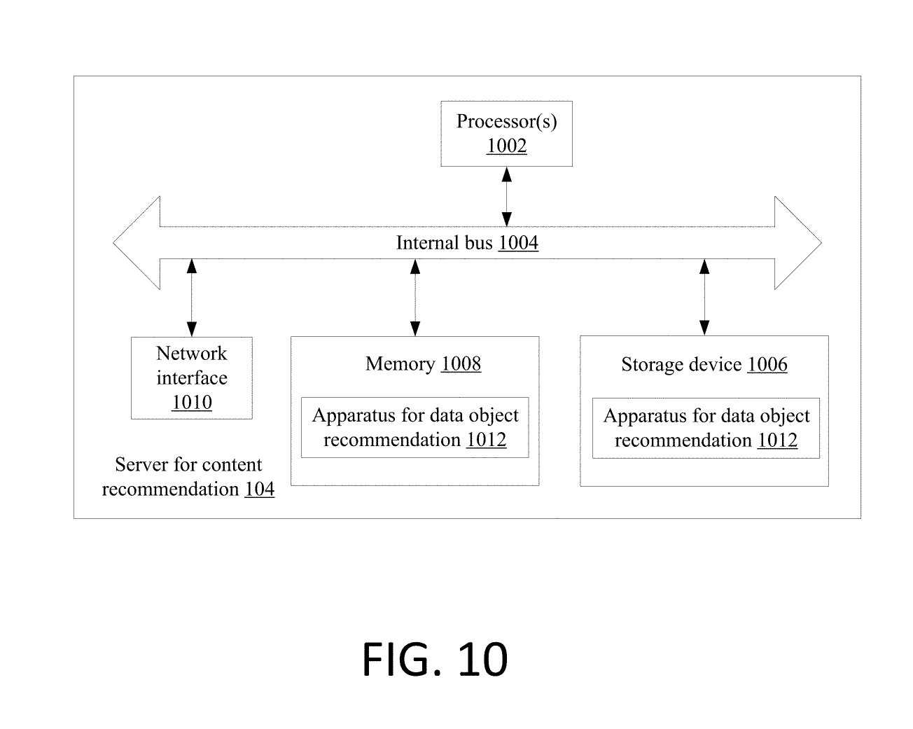

Referring to FIG. 10, in the example embodiment, the server for content recommendation 104 at hardware level may include one or more processors 1002, internal buses 1004, computer storage devices 1006, and memory 1008, and other hardware that required by other processing, such as network interface 1010.

The computer storage devices 1006 and memory 1008 are examples of computer readable media.

The computer readable media include non-volatile and volatile media as well as movable and non-movable media, and can implement information storage by means of any method or technology. Information may be a computer readable instruction, a data structure, and a module of a program or other data. A storage medium of a computer includes, for example, but is not limited to, a phase change memory (PRAM), a static random access memory (SRAM), a dynamic random access memory (DRAM), other types of RAMs, a ROM, an electrically erasable programmable read-only memory (EEPROM), a flash memory or other memory technologies, a compact disk read-only memory (CD-ROM), a digital versatile disc (DVD) or other optical storages, a cassette tape, a magnetic tape/magnetic disk storage or other magnetic storage devices, or any other non-transmission media, and can be used to store information accessible to the computing device. According to the definition herein, the computer readable media do not include transitory media, such as modulated data signals and carriers.

The processors 1002 read the corresponding computer-readable instructions or computer programs from the computer storage devices 1006 into the memory 1008 and then run, and thus the apparatus for data object recommendation 1012 is formed at logical level. Certainly, in addition to software implementation, the present disclosure does not exclude other forms of implementation, such as logical hardware components, or a combination of hardware and software. In other words, the performing entity of the present disclosure is not limited to each logical unit, and may be hardware or logical hardware components. In an example embodiment, the apparatus for content recommendation, when performed by the processors, may perform the following operations:

detecting that the natural language is input by a user into the natural language interactive interface of the client terminal and creating the personal content pool for the user;

searching matching contents from the basic content pool according to the natural language input by the user and inputting the contents into the personal content pool of the user; and

when the preset first triggering condition is satisfied, recommending the contents in the personal content pool to the user,

The details of the above operations may refer to counterparts in the above method for content recommendation and the above example server embodiment as shown in FIG. 7, which are not detailed herein.

In another example embodiment, the apparatus for content recommendation, when performed by the processors, may perform the following operations:

detecting that the keyword is input by the user into the search bar of the client terminal and creating the personal content pool for the user;

searching matching contents from the basic content pool according to the natural language input by the user and inputting the contents into the personal content pool of the user; and

when the preset second triggering condition is satisfied, recommending the contents in the personal content pool to the user.

The details of the above operations may refer to counterparts in the above method for content recommendation and the above example server embodiment as shown in FIG. 8, which are not detailed herein,

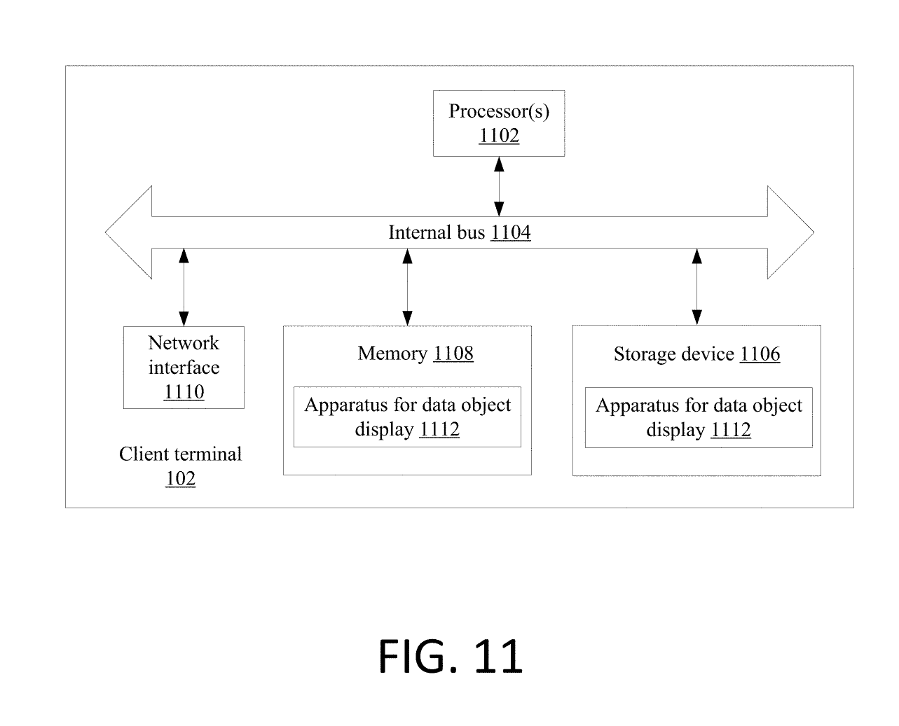

FIG. 11 illustrates hardware component of an example client terminal according to the present disclosure. The client terminal may be an implementation of the client terminal 102 as shown in FIG. 1. The client terminal may communicate with the server for content recommendation 104 as shown in FIG. 1. Referring to FIG. 11, the client terminal 102 at hardware level may include one or more processors 1102, internal buses 1104, computer storage devices 1106, and memory 1108, and other hardware that required by other processing, such as network interface 1110. The processors 1102 read the corresponding computer-readable instructions or computer programs from the computer storage devices 1106 into the memory 1108 and then run, and thus the apparatus for data object display 1112 is formed at logical level. Certainly, in addition to software implementation, the present disclosure does not exclude other forms of implementation, such as logical hardware components, or a combination of hardware and software. In other words, the performing entity of the present disclosure is not limited to each logical unit, and may be hardware or logical hardware components. The details of the above operations may refer to the corresponding portions in the above example embodiment as shown in FIG. 9 and the above described example system embodiment, which are not detailed herein.

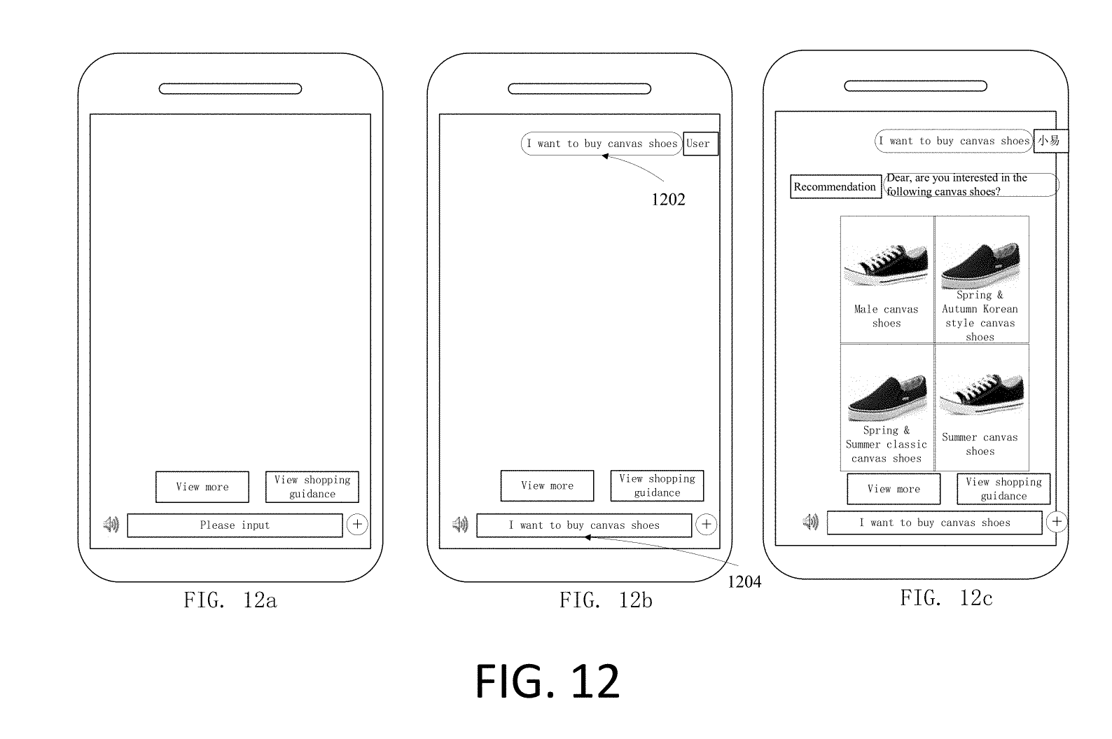

Referring to the client terminal as shown in FIG. 11 and the system as shown in FIG. 1, an example application scenario of the present disclosure is described. After initiation, the display device at the client terminal presents an interactive interface as shown in FIG. 12a for the user to input. When the user intends to search “canvas shoes,” the user inputs “I want to buy canvas shoes” 1202 via the input device of the client terminal (such as a touch screen 1202 or voice input 1204) as shown in FIG. 12b. The processor of the client terminal detects that the user inputs “I want to buy canvas shoes,” applies semantic analysis to the user input, extracts the keyword “canvas shoes”, and uploads it to the server for content recommendation. In another example embodiment, the processor of the client terminal uploads the complete user input “I want to buy canvas shoes” to the server for content recommendation. The server for content recommendation applies semantic analysis to the complete user input, and extracts the keyword “canvas shoes.” The server for content recommendation creates the personal content pool for the user, searches contents matching “canvas shoes” from the basic content pool (such as product introduction, usage comment, top sale product that are related canvas shoes), and inputs such contents to the personal content pool. After the triggering condition (such that the number of contents relating to “canvas shoes” stored in the personal content pool reaches a. preset number or threshold) is satisfied, the server for content recommendation provides multiple contents relating to “canvas shoes” in the personal content pool to the client terminal. The client terminal outputs them to the display device as shown in FIG. 12c for the user to view. The user may further interact with the client terminal as shown in FIG. 6 or FIG. 7 to obtain additional contents.

In the specification and claims of the present disclosure, the term “including” or “comprising” or their variations are open terms and shall be interpreted as “including but not limited to.”

One of ordinary skill in the art may understand that the various illustrative logical modules, units and operations described by the example embodiments of the present disclosure may be implemented via hardware, software, or a combination of hardware and software. Whether using hardware or software to implement is dependent on specific application and the design requirement of the system. One of ordinary skill in the art may use different methods to implement described functions for various specific applications. Such implementation shall be construed as within the protection of the present disclosure.

The various illustrative logical modules or unit described by the example embodiments of the present disclosure may be implemented by using general purpose processor, digital signal processor, application-specific integrated circuit (ASIC), field programmable gate array (FPGA), or other programmable logic device, discrete gate or transistor logic, discrete hardware components, or any combination of the above designed to achieve or functionality described operation. A general-purpose processor may be a microprocessor, alternatively, the general-purpose processor may be any conventional processor, controller, microcontroller, or state machine. Processor may also be implemented in combination of computing devices, e.g., a digital signal processor and a microprocessor, a plurality of microprocessors, one or more microprocessors combined with a digital signal processor core, or any other similar configuration to implementation.

In the example embodiments of the present disclosure, the described steps or operations of the method or algorithm may be embedded directly in hardware, a software module executed by a processor; or a combination of both. A software module may be stored in RAM memory, flash memory, ROM memory, EPROM memory, EEPROM memory, registers, hard disks, removable disks, CD-ROM or in any other form of computer readable media. Illustratively, the computer readable media may be connected to the processor so that the processor may read information from the computer readable media, and write information into the computer readable media. Alternatively, the computer readable media may also be integrated into the processor. Processor and the computer readable media may be provided in the ASIC and the ASIC may be provided in the user terminal. Alternatively, the processor and the computer readable media may be provided in the different components of the client terminal.

The above descriptions further illustrate the purpose, technical solution, and technical effects of the present disclosure. It should be noted that the above descriptions are just example embodiments of the present disclosure, and should not be used to limit the protection scope of the present disclosure. Any alteration, equivalent replacement, improvement within the spirit and principle of the present disclosure shall be included in the protection of the present disclosure.

What is claimed is:

1. A method comprising:
receiving a user input provided by a client terminal;
searching for matching contents from a basic content pool according to the user input, the basic content pool including one or more contents;
creating a personal content pool to store contents for a user;
inputting the matching contents into the personal content pool; and
providing a content from the personal content pool to the client terminal when a preset triggering condition is satisfied, the preset triggering condition indicating attempts of the user to search for the matching contents have reached a threshold.

2. The method of claim 1, wherein the user input includes a natural language input at a natural language interactive interface of the client terminal.

3. The method of claim 1, wherein the preset triggering condition includes at least one of the following:
a quantity of contents in the personal content pool reaches a preset threshold value;
a time period after receiving the user input reaches a preset threshold of time period; and
a quantity of times that multiple user inputs intending to describe a same scenario has reached a threshold times; or

4. The method of claim 1, wherein the user input includes a keyword input at a search bar of the client terminal,

5. The method of claim 1, further comprising:
recording a recommendation after providing the content from the personal content pool to the client terminal,

6. The method of claim 5, further comprising:
determining whether to provide the content from the personal content pool to the client terminal according to a record before providing the content in the personal content pool to the client terminal at a next time; and
determining not to provide the content from the personal content pool to the client terminal at the next time in respond to determining that the content is recorded.

7. The method of claim 1, further comprising:
providing a prompt message to the client terminal; and
selecting multiple contents from the personal content pool to provide to the client terminal after receiving a view request provided by the client terminal.

8. The method of claim 1, further comprising:
receiving a recommendation request from the client terminal; and
returning one or more online customer service interfaces of one or more merchants to the client terminal according to a preset reference condition.

9. The method of claim 8, wherein the preset reference condition includes at least one of the following:
a busy degree of an online customer service of a merchant;
a professional level of an online customer service of a merchant; and
the user input within a preset threshold of time after an initiation of the user input.

10. The method of claim 1, wherein the providing the content from the personal content pool to the client terminal includes:
receiving a view request from the client terminal, the view request being triggered when the operation tag displayed at the client terminal is clicked or triggered; and
selecting a preset quantity of contents from the multiple contents to be sent to the client terminal after selecting multiple contents from the personal content pool.

11. The method of claim 1, further comprising:
receiving an improved user input from the client terminal;
retrieving contents matching the improved user input from the basic content pool;
inputting the contents matching the improved use input into the personal content pool; and
providing the contents matching the improved use input to the client terminal.

12. The method of claim 1, wherein the personal content pool has a life cycle.

13. The method of claim 12, wherein the creating the personal content pool includes creating the personal content pool when detecting a user interaction at a user interaction interface of the client terminal; and
the method further includes:
deleting the personal content pool when detecting the user interaction at the user interaction interface is completed; or
deleting the personal content pool when an account of the user is deleted.

14. A client terminal comprising:
one or more processors; and
one or more computer readable media storing thereon computer-readable instructions, that when executed by the one or more processors, cause the one or more processors to perform acts comprising:
receiving a user input via a user interface;
providing the user input to a server for content recommendation;
receiving a content provided by the server for content recommendation from a personal content pool when a preset triggering condition is satisfied; and
displaying the content.

15. The client terminal of claim 14, wherein the user interface is a natural language user interface.

16. The client terminal of claim 14, wherein the preset triggering condition indicates attempts of the user to find an accurate user input for searching have reached a threshold.

17. The client terminal of claim 14, wherein the preset triggering condition includes at least one of the following:
a quantity of contents in the personal content pool reaches a preset threshold value;
a time period after receiving the user input reaches a preset threshold of time period; and
a quantity of times that multiple user inputs intending to describe a same scenario has reached a threshold times; or

18. The client terminal of claim 14, wherein the user interface is received by a receiving device of the client terminal.

19. The client terminal of claim 14, wherein the content is displayed at a display device of the client terminal.

20. A server comprising:
one or more processors; and
one or more computer readable media storing thereon computer-readable instructions, that when executed by the one or more processors, cause the one or more processors to perform acts comprising:
receiving a user input provided by a client terminal;
searching matching contents from a basic content pool according to the user input;
creating a personal content pool;
inputting the matching contents into a personal content pool; and
when a preset triggering condition is satisfied, providing a content from the personal content pool to the client terminal.
